(19) United States
(12) Patent Application Publication
(10) Pub. No.: US 2008/0174523 A1
(43) Pub. Date: Jul. 24, 2008

(54) Method and apparatus to drive plasma display panel (PDP)

(76) Inventors: Seung-Min Kim, Suwon-si (KR); Woo-Joon Chung, Suwon-si (KR); Seong-Joon Jeong, Suwon-si (KR); Tae-Seong Kim, Suwon-si (KR)

Correspondence Address: Robert E. Bushnell, Suite 300, 1522 K Street, N.W., Washington, DC, 20005-1202, US

(21) Appl. No.: 11/802,554

(22) Filed: May 23, 2007

(30) Foreign Application Priority Data
Jan. 19, 2007 (KR) 10-2007-0006302

(51) Int. Cl. G09G 3/28

(52) U.S. Cl. 345/63; 345/67

(57) ABSTRACT

A method and apparatus to drive a Plasma Display Panel (PDP) having X electrodes, Y electrodes, and address electrodes includes: dividing a unit frame, which is a display cycle, into a plurality of sub-fields for displaying time ratio gray-scale, each sub-field including a reset period, an address period, and a sustain period; alternately supplying a sustain pulse to the X electrode and the Y electrode based on a reference voltage in the sustain period; and reducing the width of the last sustain pulse of the sustain period in the minimum weighted sub-field, if a load factor of the minimum weighted sub-field to which the lowest gray-scale is allocated among the plurality of sub-fields is lower than the reference load factor.

### CLAIM OF PRIORITY

This application makes reference to, incorporates the same herein, and claims all benefits accruing under 35 U.S.C. §119 from an application for METHOD AND APPARATUS FOR DRIVING PLASMA DISPLAY PANEL earlier filed in the Korean Intellectual Property Office on the 19^{th} day of January 2007 and there duly assigned Serial No. 10-2007-0006302.

### BACKGROUND OF THE INVENTION

1. Field of the Invention

The present invention relates to a method and apparatus to drive a Plasma Display Panel (PDP). More particularly, the present invention relates to a PDP and a method of driving the PDP so as to reduce brightness for minimum weighted sub-fields.

2. Description of the Related Art

Recently, Plasma Display Panels (PDPs) have become widely popular as large flat panel displays. In a PDP, a discharge gas is injected between two substrates on which a plurality of electrodes are formed, a discharge voltage is supplied to the electrodes, and phosphors formed with a predetermined pattern are excited due to ultraviolet rays generated by the discharge voltage, thereby displaying a desired image.

An apparatus for driving a PDP includes a plurality of voltage sources and a plurality of driving ICs. The voltage sources are disposed in the PDP in order to supply driving signals to each electrode and the driving ICs control a plurality of switching devices and their switching operations. The driving signals are outputted from the apparatus for driving a PDP due to the switching operations of the switching devices.

Generally, in a PDP, a unit frame is divided into a plurality of sub-fields and a gray-scale is displayed by a combination of the sub-fields. Each of the sub-fields includes a reset period, an address period, and a sustain discharge period. First, in the reset period, wall charges formed by previous sustain discharges are removed and new wall charges are set up in order to stably perform an address discharge. Then, in the address period, cells that are to be turned on in a panel and cells not to be turned on in a panel are selected. The wall discharges build up in the selected cells that are to be turned on (addressed cells). Then, in the sustain period, sustain discharge operations are performed to display an image on the addressed cells.

In order to improve low gray-scale displaying capacity of a PDP, a light output in the minimum weighted sub-fields, which generate the lowest brightness among the sub-fields, that is, a unit light, should be reduced. However, according to a conventional method of driving, the brightness of a unit light increases and thus the gray-scale displaying capacity is significantly reduced.

### SUMMARY OF THE INVENTION

The present invention provides a Plasma Display Panel (PDP) and a method of driving the PDP in order to control the light output of a sustain period so as to reduce the brightness of the minimum weighted sub-fields, thereby improving the gray-scale displaying capacity.

According to one aspect of the present invention, a method of driving a Plasma Display Panel (PDP) having X, Y, and address electrodes is provided, the method including: dividing a unit frame, corresponding to a display cycle, into a plurality of sub-fields to display time ratio gray-scales, each sub-field including a reset period, an address period, and a sustain period; alternately supplying a sustain pulse during the sustain period to X and Y electrodes based on a reference voltage; and reducing a width of a last sustain pulse of the sustain period in a minimum weighted sub-field in response to a load factor of the minimum weighted sub-field having a lowest gray-scale among the plurality of sub-fields being lower than a reference load factor.

The width of the last sustain pulse of the sustain period in the minimum weighted sub-field and a width of sustain pulse just prior to the last sustain pulse are preferably decreased in response to the load factor of the minimum weighted sub-field being lower than a reference load factor.

The decrease in width of the last sustain pulse is preferably greater than the decrease in width of the sustain pulse just prior to the last sustain pulse.

The last sustain pulse of the sustain period in the minimum weighted sub-field is preferably supplied to the Y electrodes.

According to another aspect of the present invention, a method of driving a Plasma Display Panel (PDP) having cells divided into a plurality of groups and having the cells included in each group being addressed and a sustain discharge effected by X, Y, and address electrodes is provided, the method including: dividing one frame into a plurality of sub-fields, allocating a gray-scale realized by each sub-field differently, and determining a gray-scale according to visible brightness of the cells by selectively driving each sub-field; in at least one sub-field: operations of the address period and the sustain period are sequentially performed with respect to the cells in each group, the sustain period operations are performed with respect to the cells of an addressed group after the address operations with respect to the cells in each group; the address operations are performed on the cells in other groups after the sustain period has been completed; and the sustain period operations are selectively performed on the cells in other groups in which the address operations have already been performed while the sustain period operations are being performed on the cells in any one of the groups; alternately supplying a sustain pulse to the X and Y electrodes based on a reference voltage during the sustain period; and reducing a width of the last sustain pulse of the sustain period in a minimum weighted sub-field in response to the load factor of the minimum weighted sub-field having the lowest gray-scale among the plurality of sub-fields being lower than a reference load factor.

The width of the last sustain pulse of the sustain period in the minimum weighted sub-field and the width of the sustain pulse just prior to the last sustain pulse are preferably decreased in response to the load factor of the minimum weighted sub-field being lower than the reference load factor.

The decrease in width of the last sustain pulse is preferably greater than the decrease in width of the sustain pulse just prior to the last sustain pulse.

The last sustain pulse of the sustain period in the minimum weighted sub-field is preferably supplied to the Y electrodes.

The method preferably further includes a common period in which the sustain period is commonly performed on cells included in all groups for a predetermined period.

The method preferably further includes a compensation period in which additional sustain period operations are selectively performed on cells in all groups for the cells in each group to satisfy a predetermined gray-scale.

According to still another aspect of the present invention, an apparatus to drive a Plasma Display Panel (PDP) including X, Y, and address electrodes is provided, the apparatus including: electrode driving units to drive X, Y, and address electrodes with driving signals during each sub-field including a reset period and an address period and a sustain period, a unit frame corresponding to a display cycle including a plurality of sub-fields to display a time ratio gray-scale, and to alternately supply a sustain pulse to the X and Y electrodes based on a reference voltage during the sustain period; a load factor detecting unit to detect load factors in each sub-field; and a sustain pulse width control unit to decrease a width of a last sustain pulse of the sustain period in a minimum weighted sub-field in response to the load factor of the minimum weighted sub-field having the lowest gray-scale among the plurality of sub-fields being lower than a reference load factor.

The sustain pulse width control unit preferably decreases the width of the last sustain pulse of the sustain period in the minimum weighted sub-field and a width of a sustain pulse just prior to the last sustain pulse in response to the load factor of the minimum weighted sub-field being lower than the reference load factor.

The sustain pulse width control unit preferably decreases the width of the last sustain pulse more than that of the width of the sustain pulse just prior to the last sustain pulse.

The sustain pulse width control unit preferably supplies the last sustain pulse of the sustain period in the minimum weighted sub-field to the Y electrodes.

According to yet another aspect of the present invention, an apparatus to drive a Plasma Display Panel (PDP) having cells divided into a plurality of groups and having cells included in each group being addressed and a sustain discharge being effected by X, Y, and address electrodes included therein is provided, the apparatus including: electrode driving units to supply driving signals to the X, Y, and address electrodes, the driving signals dividing one frame into a plurality of sub-fields, to allocate a gray-scale realized by each sub-field differently, and to determine a gray-scale according to visible brightness of the cells by selectively driving each sub-field; and, in at least one sub-field, the driving signals sequentially perform operations of the address period and the sustain period with respect to the cells in each group, perform the sustain period operations with respect to the cells of addressed group after the address operations with respect to the cells in each group, perform the address operations on the cells in other groups after the sustain period has been completed, and selectively perform the sustain period operations on the cells in other groups in which the address period operations have already been performed while the sustain period operations are being performed on the cells in any one of the groups; and to alternately supply a sustain pulse to the X electrodes and the Y electrodes based on a reference voltage during the sustain period; a load factor detecting unit to detect load factors in each sub-field; and a sustain pulse width control unit to reduce a width of a last sustain pulse of the sustain period in a minimum weighted sub-field in response to a load factor of a minimum weighted sub-field having the lowest gray-scale among the plurality of sub-fields being lower than the reference load factor.

The sustain pulse width control unit preferably decreases a width of the last sustain pulse of the sustain period in the minimum weighted sub-field and a width of a sustain pulse just prior to the last sustain pulse in response to the load factor of the minimum weighted sub-field being lower than the reference load factor.

The decrease in width of the last sustain pulse is preferably greater than the decrease in width of the sustain pulse just prior to the last sustain pulse.

The sustain pulse width control unit preferably supplies the last sustain pulse of the sustain period in the minimum weighted sub-field to the Y electrodes.

The electrode driving units preferably commonly perform the sustain period operations during a common period on cells included in all of the groups for a predetermined period.

The electrode driving units preferably selectively perform additional sustain period operations during a compensation period on cells in all of the groups for the cells in each group to satisfy a predetermined gray-scale.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of an example of a Plasma Display Panel (PDP) which can be operated according to an embodiment of the present invention;

FIG. 2 is a cross-sectional view of a unit display cell of the PDP of FIG. 1;

FIG. 3 is a view of the arrangement of electrodes in the PDP of FIG. 1;

FIG. 4 is a block diagram of an apparatus to drive a PDP according to an embodiment of the present invention;

FIG. 5 is a block diagram of a logical control unit included in the apparatus to drive the PDP of FIG. 4;

FIG. 6 is a timing diagram of a method of driving a PDP according to an embodiment of the present invention in which one frame is divided into a plurality of sub-fields.

FIG. 7 is a timing diagram of driving signals outputted to electrodes of a PDP according to an embodiment of the present invention in the first sub-field of FIG. 6;

FIG. 8 is a timing diagram of a method of driving a PDP according to another embodiment of the present invention in which cells therein are divided into a plurality of groups and one frame is divided into a plurality of sub-fields;

FIG. 9 is a timing diagram for explaining in detail the method of operating the PDP of FIG. 8; and

FIG. 10 is a timing diagram of driving signals outputted to electrodes of a PDP according to an embodiment of the present invention in the first sub-field of FIG. 9.

### DETAILED DESCRIPTION OF THE INVENTION

Hereinafter, the present invention is described more fully with reference to the accompanying drawings, in which exemplary embodiments of the present invention are shown.

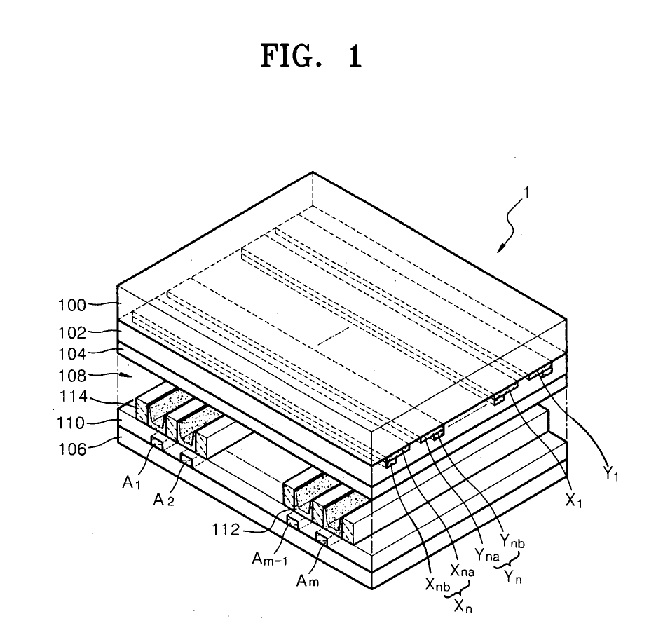

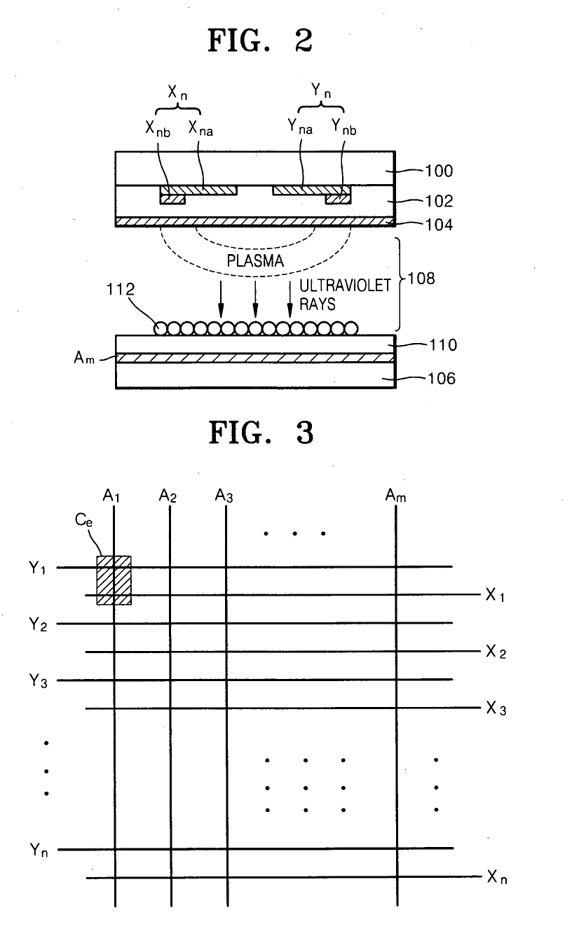

FIG. 1 is a view of an example of a Plasma Display Panel (PDP) which can be operated according to an embodiment of the present invention and FIG. 2 is a cross-sectional view of a unit display cell of the PDP of FIG. 1.

Referring to FIGS. 1 and 2, a PDP 1 includes A electrodes A1 through to Am, first and second dielectric layers 102 and 110, Y electrodes Y1 through to Yn, X electrodes X1 through to Xn, phosphor layers 112, barrier ribs 114, and a MgO protection layer, between a first substrate 100 and a second substrate 106.

The A electrodes A1 through to Am are formed in a predetermined pattern on the second substrate 106 facing the first substrate 100. The second dielectric layer 110 is formed to cover the A electrodes A1 through to Am. The barrier ribs 114 are formed parallel to the A electrodes A1 through to Am on the second dielectric layer 110. These barrier ribs 114 partition discharge spaces of the respective discharge cells and prevent optical interferences between the respective discharge cells. The phosphor layers 112 are formed between the barrier ribs 114 on the second dielectric layer 110 over the A electrodes A1 through to Am. Each phosphor layer includes a red-emitting phosphor layer, a green-emitting phosphor layer, and a blue-emitting phosphor layer, which are sequentially arranged.

The X electrodes X1 through to Xn and the Y electrodes Y1 through to Yn are formed in a predetermined pattern on the first substrate 100 facing the second substrate 106 in such a manner as to intersect the A electrodes A1 through to Am. Each intersecting point sets corresponding discharge cells. Each of the X electrodes X1 through to Xn and the Y electrodes Y1 through to Yn is formed by coupling a transparent electrode made of a transparent conductive material, such as Indium Tin Oxide (ITO) with a metal electrode (Xnb andynb) so as to increase conductivity. The first dielectric layer 102 is formed to entirely cover the X electrodes X1 through to Xn and the Y electrodes Y1 through to Yn. The protection layer 104 for protecting the PDP from a strong electric field, for example, a MgO layer, is entirely formed on first dielectric layers 102. A plasma forming gas is contained within discharge spaces 108.

A PDP operated by a driving apparatus or method of an embodiment of the present invention is not limited to that of FIG. 1. That is, a PDP having a two electrodes structure, in which only two electrodes are arranged, can be used instead of the PDP having the three electrodes structure of FIG. 1. In addition, PDPs having various structures can be used and any PDPs, which can be operated by a driving method of an embodiment of the present invention, are possible.

FIG. 3 is a view of the arrangement of electrodes in the PDP of FIG. 1.

Referring to FIG. 3, the Y electrodes Y1 through to Yn and the X electrodes X1 through to Xn are arranged parallel to each other. A electrodes A1 through to Am are arranged so as to intersect the Y electrodes Y1 through to Yn and the X electrodes X1 through to Xn. In this case, the intersected areas partition the discharge cells Ce.

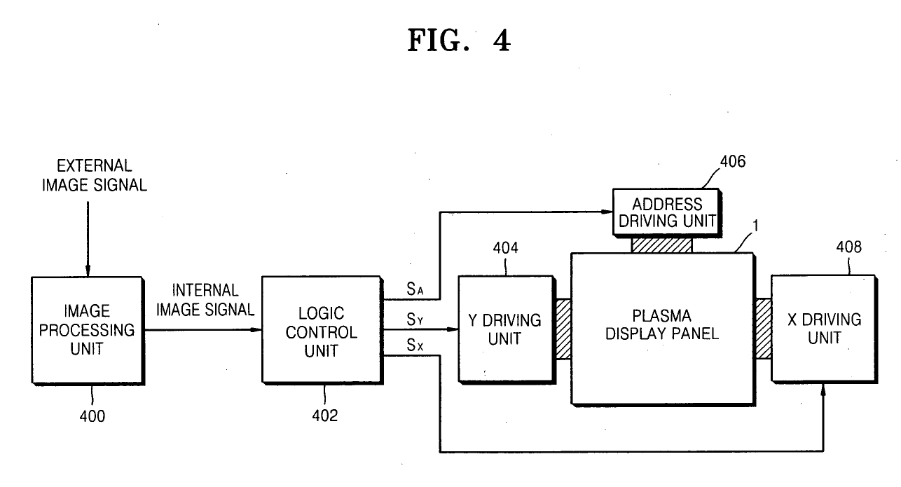

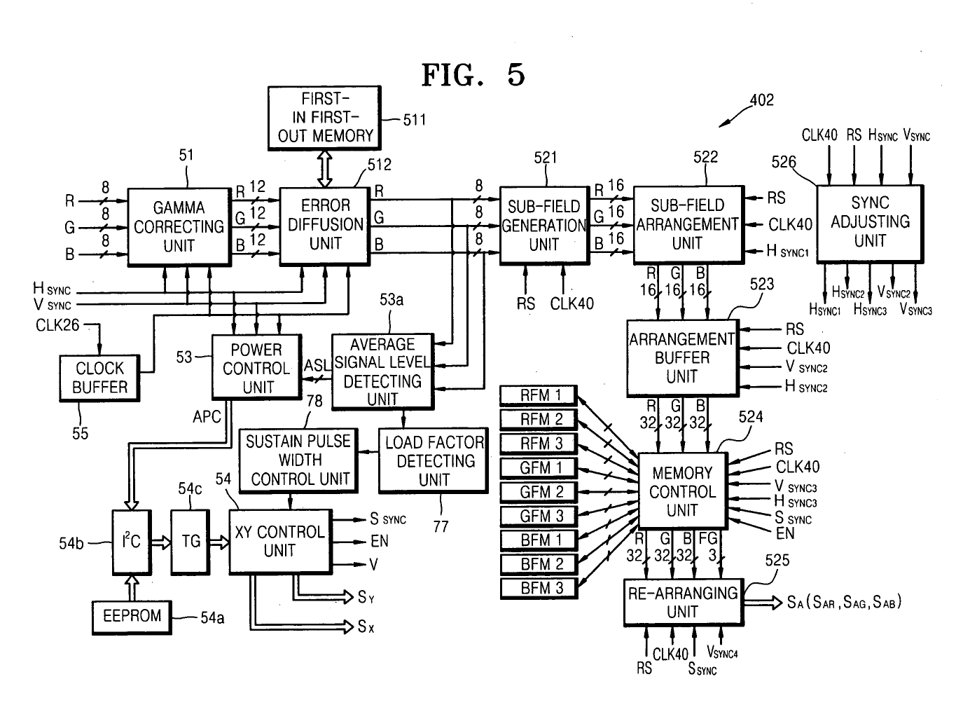

FIG. 4 is a block diagram of an apparatus to drive a PDP according to an embodiment of the present invention.

Referring to FIG. 4, an apparatus to drive the PDP 1 includes an image processing unit 400, a logical control unit 402, an address driving unit 406, an X driving unit 408, and a Y driving unit 404. The image processing unit 400 converts external analog image signals into digital signals so as to generate internal image signals, for example, 8 bit red (R), green (G), and blue (B) image data, clock signals, and vertical and horizontal sync signals. The logical control unit 402 generates driving control signals SA, SY, and SX according to image signals of the image processing unit 400. The address driving unit 406 processes the address signal SA in order to generate a display data signal and to supply the display data signal to address electrode lines. The X driving unit 408 processes the X driving control signal SX so as to supply it to X electrode lines. The Y driving unit 404 processes the Y driving control signal SY so as to supply it to Y electrode lines.

FIG. 5 is a block diagram of the logical control unit 402 included in the apparatus to drive a PDP according to an embodiment of the present invention of FIG. 4.

Referring to FIG. 5, the logical control unit 402 includes a clock buffer 55, a sync adjusting unit 526, a gamma correcting unit 51, an error diffusion unit 512, a First-In First-Out memory 511, a sub-field generation unit 521, a sub-field arrangement unit 522, an arrangement buffer unit 523, a memory control unit 524, frame-memories RFM1 through BFM3, a re-arranging unit 525, an average signal level detecting unit 53a, a power control unit 53, an EEPROM 54a, an 1²C serial communications interface 54b, a timing-signal generator 54c, an XY control unit 54, a load factor detecting unit 77, and a sustain pulse width control unit 78.

The clock buffer 55 converts a 26 MHz clock signal CLK26 generated by the image processing unit 400 of FIG. 4 into a 40 MHz clock signal CLK40 that is to be output. In the sync adjusting unit 526, the 40 MHz clock signal CLK40 from the clock buffer 55, an external initialization signal RS, and both horizontal sync signal HSYNC and vertical sync signal VSYNC from the image processing unit 400 of FIG. 4 are inputted. The inputted horizontal sync signal HSYNC results in vertical sync signals HSYNC1, HSYNC2, and HSYNC3 being output, wherein each of the vertical sync signals HSYNC1, HSYNC2, and HSYNC3 are delayed according to a predetermined number of clocks, while the inputted vertical sync signal VSYNC results in vertical sync signals VSYNC2 and VSYNC3 being output, wherein the vertical sync signals VSYNC2 and VSYNC3 are delayed according to a predetermined number of clocks.

In order to compensate for a nonlinear input-output characteristic of a PDP, image data R, G, and B inputted into the gamma correcting unit 51 have a reverse nonlinear input-output characteristic. Therefore, the gamma correcting unit 51 processes the image data R, G, and B having a reverse nonlinear input-output characteristic to have a linear input-output characteristic. The error diffusion unit 512 moves a position of the most significant bit, which is a boundary bit of the image data R, G, and B, using the First-In First-Out memory 511 and thus data transfer error is reduced.

The sub-field generation unit 521 converts the 8 bit image data R, G, and B, into image data R, G, and B having bits corresponding to a number of sub-fields. For example, if a gray-scale operation is performed in a unit frame as 14 sub-fields, the 8 bit image data R, G, and B, are converted into 14 bit image data R, G, and B. Then, in order to reduce data transfer error, invalid data ‘0’ of the Most Significant Bit (MSB) and the Least Significant Bit (LSB) is added so as to output 16 bit image data R, G, and B.

The sub-field arrangement unit 522 rearranges the 16 bit image data R, G, and B into which each different sub-fields data has been inputted at the same time and outputs the data having the same sub-fields at the same time. The arrangement buffer unit 523 processes the 16 bit image data R, G, and B from the sub-field arrangement unit 522 and outputs the data as 32 bit data R, G, and B.

The memory control unit 524 includes memory control units for red (R), green (G), and blue (B), in order to control 3 frame-memories RFM1, RFM2, and RFM3, 3 frame-memories GFM1, GFM2, and GFM3, and 3 frame-memories BFM1, BFM2, and BFM3, respectively. Frame data from the memory control unit 524 is continuously output in a frame unit and is input into the re-arranging unit 525.

The reference EN in the drawing refers to an enable signal generated by the XY control unit 54 and inputted into the memory control unit 524, in order to control the data output of the memory control unit 524. In addition, the reference SSYNC refers to a slot sync signal generated by the XY control unit 54 and inputted into the memory control unit 524 and the re-arranging unit 525, in order to control the input-output of data in a 32 bit slot unit from the memory control unit 524 and the re-arranging unit 525. The re-arranging unit 525 rearranges the 32 bit data image R, G, and B from the memory control unit 524 to conform to an input form of an address driving unit 406 of FIG. 4 and then outputs the data.

The average signal level detecting unit 53a detects an Average Signal Level (ASL) in a frame unit from each of the 8 bit image data R, G, and B generated by the error diffusion unit 512 and inputs the ASL into the power control unit 53. The power control unit 53 generates discharge number control data, that is, Automatic Power Control (APC) data, which corresponds to the ASL inputted from the average signal level detecting unit 53a and thus an auto power control operation is performed to ensure that power consumption is stable in each frame. For example, when the power control unit 53 has a corresponding frame load factor of over 30%, the auto power control operation is performed. In the EEPROM 54a, timing control data according to a driving sequence of the X and Y electrode lines is stored. The discharge number control data from the power control unit 53 and the timing control data from the EEPROM 54a are inputted in the timing-signal generator 54c through the 1²C serial communications interface 54b. The timing-signal generator 54c is operated according to inputted the discharge number control data and timing control data and generates a timing-signal. The XY control unit 54 is operated according to the timing-signal from the timing-signal generator 54c and outputs the X driving control signal SX and the Y driving control signal SY.

The load factor detecting unit 77 detects a load factor to input into the sustain pulse width control unit 78 and thus controls the sustain pulse width of the minimum weighted sub-fields according to the load factor. The load factor can be proportional to the number of discharge cells which will be displayed with respect to all of the discharge cells in the sub-fields. The load factor can be used in detecting the ASL in the average signal level detecting unit 53a. According to an embodiment of the present invention, the load factor refers to an average load factor of the load factors for each sub-field in the corresponding frames and the load factors for each sub-field can refer to a proportion of the number of cells which will be displayed with respect the total number of cells of a PDP. The load factors can be directly obtained from data outputted by the error diffusion unit 512.

When the load factor of the minimum weighted sub-field detected in the load factor detecting unit 77 is lower than the standard load factor, the sustain pulse width control unit 78 generates a signal which reduces the last sustain pulse width and/or the sustain pulse width just before the last sustain pulse width of the sustain period of the minimum weighted sub-field, to be input into the timing-signal generator 54c or the XY control unit 54.

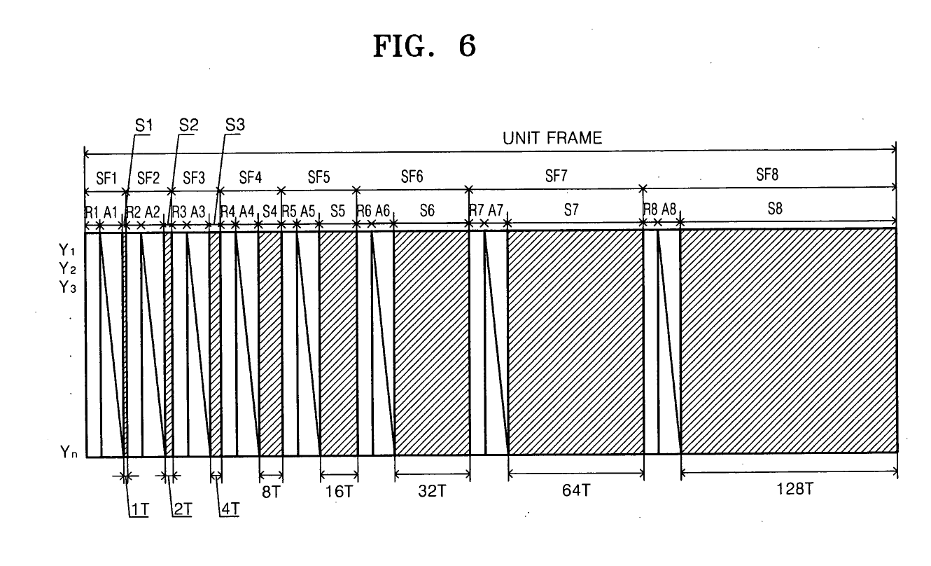

FIG. 6 is a timing diagram of a method of driving a PDP according to an embodiment of the present invention in which one frame is divided into a plurality of sub-fields.

Referring to FIG. 6, in order to realize a time ratio gray-scale display, a unit frame can be divided into a predetermined number of sub-fields, for example, 8 sub-fields SF1 through to SF8. In addition, each of the sub-fields SF1 through to SF8 can be divided into the reset period R1 through to R8, the address period A1 through to A8, and the sustain period S1 through to S8.

In each reset period R1 through to R8, a reset pulse is supplied to the Y electrodes Y1 through to Yn and thus all cells have the same wall discharge condition that is to be initialized.

In each address period A1 through to A8, an address pulse is supplied to the A electrodes and a scan pulse corresponding to each of the Y electrodes Y1 through to Yn is sequentially supplied to the A electrodes at the same time.

In each sustain period S1 through to S8, a sustain pulse is alternately supplied to the Y electrodes Y1 through to Yn and the X electrodes X1 through to Xn and thus a sustain discharge occurs in the discharge cells in which wall charges are formed in the address period A1 through to A8.

The brightness of a PDP is proportional to the number of sustain discharge pulses in each sustain period S1 through to S8 occupying the unit frame. For example, when one frame which forms an image is displayed as 8 sub-fields and 256 gray-scales, each different number of sustain pulses can be allocated to each sub-field sequentially in the ratio of 1, 2, 4, 8, 16, 32, 64, and 128. In order to obtain 133 gray-scale brightnesses, cells may be addressed to respectively perform a sustain discharge during the first, third, and eighth sub-fields, SF1, SF3, and SF8.

The number of sustain discharges allocated to each sub-field may vary according to weights of sub-fields based on Automatic Power Control (APC). In addition, the number of sustain discharges allocated to each sub-field can vary according to gamma characteristics and PDP characteristics. For example, the gray-scale allocated to the fourth sub-field SF4 can lower from 8 to 6 and the gray-scale allocated to the sixth sub-field SF6 can rise from 32 to 34. A number of sub-fields forming one frame can also vary according to design specifications.

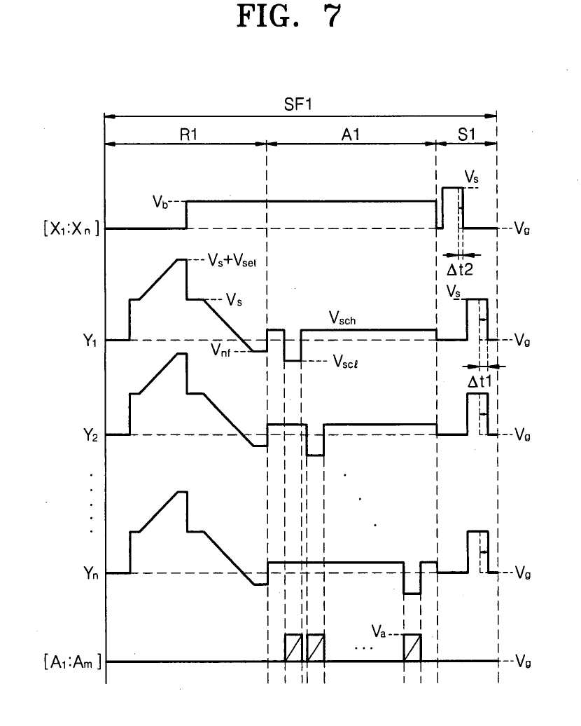

FIG. 7 is a timing diagram of driving signals outputted to electrodes of a PDP according to an embodiment of the present invention in the first sub-field of FIG. 6.

Referring to FIG. 7, a unit frame for driving the PDP 1 of FIG. 4 is divided into a plurality of sub-fields and the first sub-field SF1 is divided into the reset period R1, the address period A1, and the sustain period S1.

In the reset period R1 of the first sub-field SF1, after the last sustain pulse (not illustrated) is supplied in the previous sustain period, a first voltage Vs, a voltage having a rising slope from the level of the first voltage Vs to the level of the second voltage Vs+Vset, the first voltage Vs, and a reset pulse which supplies a voltage having a falling slope from the level of the first voltage Vs to the level of the sixth voltage Vnf, are supplied sequentially to the Y electrodes Y1 through to Yn. A reference voltage Vg, for example, ground voltage, is supplied to the address electrodes A1 through to Am. In addition, when a rising lamp voltage is supplied to the Y electrodes Y1 through to Yn, the reference voltage Vg is supplied to the X electrodes X1 through to Xn. When a falling lamp voltage is supplied to the Y electrodes Y1 through to Yn, a seventh voltage Ve is supplied to the X electrodes X1 through to Xn.

As described above, while the lamp voltage is rising, a weak discharge occurs from the Y electrodes Y1 through to Yn to the address electrodes A1 through to Am and the X electrodes X1 through to Xn. Due to such a weak discharge, negative wall charge is accumulated in the Y electrodes Y1 through to Yn and positive wall charge is accumulated in the address electrodes A1 through to Am and the X electrodes X1 through to Xn.

In addition, while the lamp voltage is falling, a weak discharge occurs from the address electrodes A1 through to Am and the X electrodes X1 through to Xn to the Y electrodes Y1 through to Yn due to wall charges formed in the discharge cells. According to such a weak discharge, wall charges formed in the X electrodes X1 through to Xn, the Y electrodes Y1 through to Yn, and the address electrodes A1 through to Am are partly removed so as to be set as a state that is appropriate for addressing. The address period A1 selects the discharge cell in which a sustain discharge generated in the sustain period S1 by address discharge will be performed. In the address period A1, the seventh voltage Ve is continuously supplied to the X electrodes X1 through to Xn, scan pulses are sequentially supplied to the Y electrodes Y1 through to Yn, and display data signals corresponding to the scan pulses are supplied to the address electrodes A1 through to Am, thereby performing an address discharge. The scan pulse maintains the eighth voltage Vsch and sequentially maintains the ninth voltage Vscl which is lower than the eighth voltage Vsch. The display data signal maintains the tenth voltage Va having a constant polarity synchronized when a scan pulse is supplied to the ninth voltage Vscl.

In the discharge cells selected during the address period A1, a sustain discharge occurs due to a sustain pulse being supplied from the sustain period. In the discharge cells not selected during the address period A1, a discharge does not occur even when a sustain pulse is supplied in the sustain period.

In the sustain period SI, a sustain pulse is alternately supplied to the X electrodes X1 through to Xn and the Y electrodes Y1 through to Yn and thus sustain discharge is performed. The brightness of a unit field formed of a plurality of sub-fields is displayed after a sustain discharge occurs according to gray-scale weights allocated to each sub-field. Sustain pulses alternately have the fifth voltage Vs and the reference voltage Vg. In the sustain period S1 of the first sub-field SF1, sustain pulses are supplied to the X electrodes X1 through to Xn once and sustain pulses are supplied to the Y electrodes Y1 through to Yn once, sequentially.

If the load factor of the first sub-field SF1 which indicates the minimum weighted sub-field is lower than the reference load factor, the last sustain pulse of the sustain period S1 in the first sub-field SF1, that is, the width of the sustain pulse supplied to the Y electrodes Y1 through to Yn, is reduced. Accordingly, unit light of a PDP is reduced and thus the low gray-scale displaying capacity is improved.

In addition, the sustain pulse just prior to the last sustain pulse, that is, the width of the sustain pulse supplied to the X electrodes X1 through to Xn can be additionally reduced. The low gray-scale displaying capacity can be improved. However, the discharge stability may be reduced. Therefore, as a decrease in width Δt1 of the last sustain pulse supplied to the Y electrodes Y1 through to Yn is larger than a decrease in width Δt2 of the sustain pulse just prior to the last sustain pulse supplied to the X electrodes X1 through to Xn, discharge stability can be secured and the low gray-scale displaying capacity can be improved even more.

As illustrated in FIG. 7, since the last sustain pulse of the sustain period S1 in the minimum weighted sub-field SF1 is supplied to the Y electrodes Y1 through to Yn, instead of the X electrodes X1 through to Xn, a wall charge state of the Y electrodes formed of negative charges due to one reset operation is prevented from being disturbed. Therefore, a wall charge state of the Y electrodes is stably maintained and is advantageous for address discharge, and thereby stable address discharge can be performed.

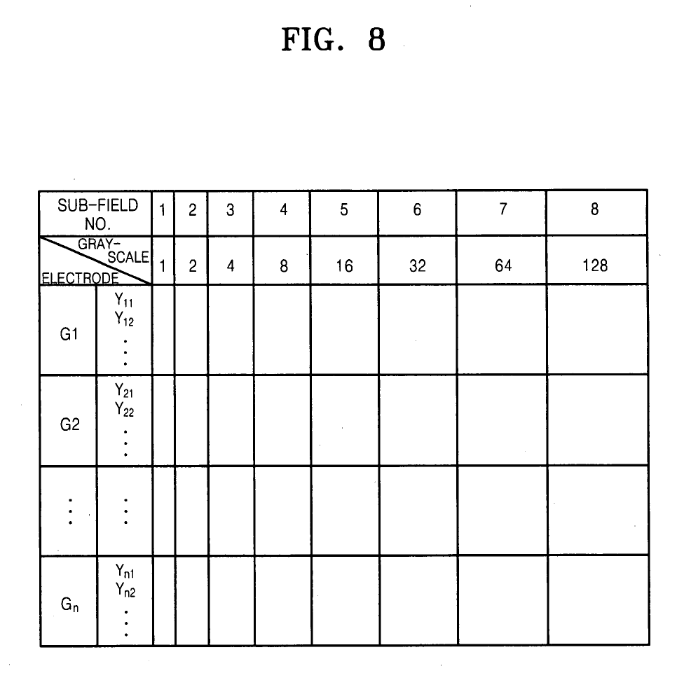

FIG. 8 is a timing diagram of a method of driving a PDP according to another embodiment of the present invention in which cells therein are divided into a plurality of groups and one frame is divided into a plurality of sub-fields.

Referring to FIG. 8, in order to achieve 256 gray-scales, one frame forming an image is generally divided into 8 sub-fields and each different number of sustain pulses are allocated to each of the sub-fields sequentially in the ratio of 1, 2, 4, 8, 16, 32, 64, and 128. Also, the sustain period for each sub-field is allocated in proportion to the above ratio. In addition, as one method of dividing cells constituting a panel into a plurality of groups, the Y electrodes are divided into n groups G1 through Gn.

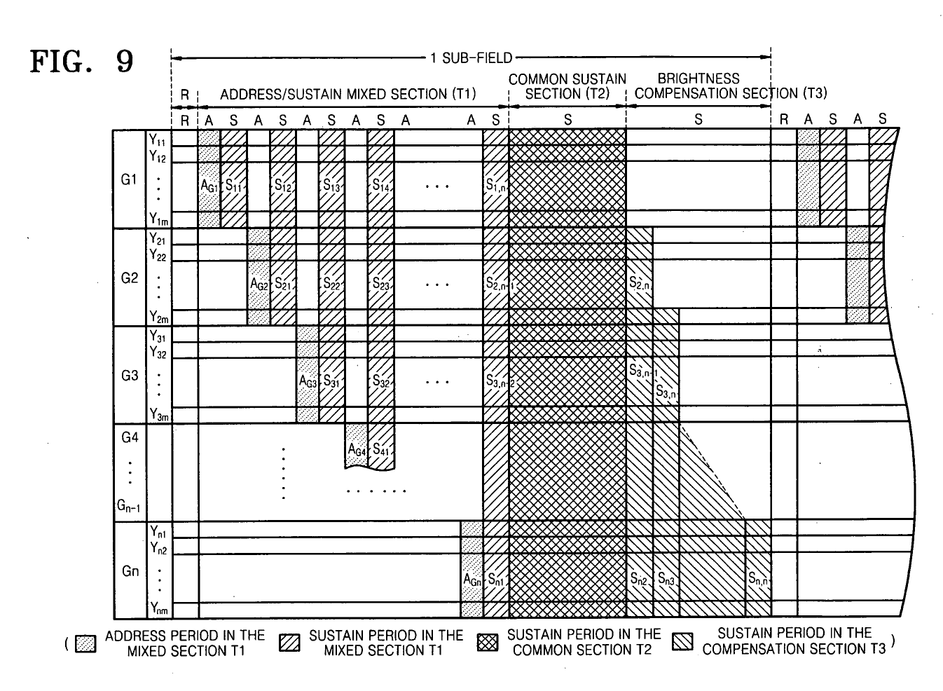

FIG. 9 is a timing diagram for explaining in detail a method of operating the PDP of FIG. 8.

Referring to FIG. 9, one frame period is divided into a plurality of sub-fields and gray-scales realized by each sub-field are each allocated differently. The Y electrodes are divided into a plurality of groups G1 through Gn and an address action is sequentially performed with respect to the Y electrodes included in each group. When the address action with respect to any one of the groups is completed, a sustain discharge pulse is supplied to Y electrodes of this group to perform the sustain period operations. If the sustain period operations are performed with respect to Y electrodes of any one of the groups, sustain period operations with respect to the Y electrodes of other groups in which the address action is already carried out can be selectively performed. As such, the address period with respect to the cells of any one of the groups is followed by the sustain period within a certain period of time. Then, the address period operations are performed with respect to the Y electrodes of other groups in which the address action is not yet performed. While the Y electrodes constituting one panel are divided into a plurality of groups, the number of Y electrodes included in each group may be divided equally or adjusted differently.

In FIG. 9, one sub-field includes the reset period R, the address/sustain mixed section T1, the common sustain section T2, and the brightness compensation section T3. Blocks marked by dots are the address period in the mixed section T1, shaded portions with left slashes are the sustain period in the mixed section T1, shaded portions with both left and right slashes are the sustain period in the common section T2, and shaded portions with right slashes are the sustain period in the compensation section T3.

The common section T2 and the brightness compensation section T3 can be supplied or not supplied according to the sub-fields. Whether to supply the common section T2 and the brightness compensation section T3 is determined according to specifications of gray-scales allocated to the sub-fields. If the sub-field to which a low gray-scale is allocated, then the sustain period required for realizing the gray-scale is relatively short. If the sub-field to which a high gray-scale is allocated, then the sustain period required for realizing the gray-scale is relatively long. Therefore, the sub-field having low gray-scale may include only the address/sustain mixed section T1 and the sub-field having high gray-scale may include all of the address/sustain mixed section T1, the common sustain section T2, and the brightness compensation section T3. The sub-field to which an intermediate level of gray-scale is allocated may include the address/sustain mixed period T1 and the brightness compensation section T3 without the common sustain section T2.

In the reset period R, a reset pulse is supplied to scan lines of all groups and thus a wall charge state of the cell is initialized. Due to the reset period operation R that is performed once before the address/sustain mixed period T1 of each sub-field, wall charge conditions of all cells are similar.

The address/sustain mixed section T1 is described as follows. In the first group G1, a scan pulse is sequentially supplied to the first Y electrode Y₁₁ through to the last Y electrode Y₁ₘ in order to perform the address period AG1. When the address action with respect to the cells in the first group is completed, the sustain period S11 operation, in which sustain discharges are supplied to these addressed cells by using a predetermined number of sustain pulses, is performed.

When the first sustain period S11 of the first group is completed, the address period AG2 with respect to the cells in the second group is performed. During the address period AG2 of the second group, an additional enable pulse should not be supplied to the cells in other groups. However, in the address period AG2 of the second group, sustain pulses can be supplied to the electrodes of other groups during the time-gap after the scan pulse is supplied to the current Y electrode and before the scan pulse is supplied to the next Y electrode. This can be also supplied to the address period of other groups.

When the address period AG2 of the second group is completed, that is the address actions with respect to the Y electrodes included in the second group is completed, the first sustain period S21 operations with respect to the second group is performed. The second sustain period S12 operations are performed in the first group in which the address period operations are already performed. However, if the gray-scale is satisfied by the first sustain period S11 of the first group, the second sustain period S12 operations of the first group may not be performed. The cells in which the address period operations are not yet performed remains in standby.

When the first sustain period S21 of the second group is completed, the operations of address period SG3 and the first sustain period S31, both with respect to the third group, are performed in the same manner as described above. While the first sustain period S31 operations with respect to the third group are performed, the operations of the sustain periods S13 and S22 can be performed with respect to the cells of the first and second groups in which the address period operations are already performed. However, if the gray-scale is satisfied by the first sustain period S11 and S21 of the first and second groups, the operations of additional sustain periods S13 and S22 may not be performed.

After the procedures described above have been performed, a scan pulse is sequentially supplied to the Y electrodes included in the last group Gn in order to perform operations of the address period AGn and then operations of the sustain period Sn1 are performed. While the sustain period Sn1 operations are performed, operations of the sustain period with respect to the cells of other groups are also performed.

In FIG. 9, while the sustain period operations are performed on the cells of any one of the groups, sustain period operations are also performed on all cells of the groups in which the address actions have already been performed. If the number of sustain pulses supplied during the unit sustain period is the same and thus the brightness revealed is the same, the cells included in the first group will show brightness n times brighter than the cells in the n-th group. Similarly, the cells in the second groups will show brightness n-1 times brighter than the cells of the n-th group and the cells in the (Gn-1)th group will show brightness twice that of the cells of the n-th group. In order to uniformly compensate for brightness differences of each group, an additional predetermined sustain period is required and this is the brightness compensation section T3 of FIG. 9.

The brightness compensation section T3 is the second sustain discharge selectively performed for each group in order for gray-scales of the cells in each group to be compensated uniformly.

In the common sustain section T2, a sustain pulse is commonly simultaneously supplied to all cells for a predetermined period of time. The common sustain section T2 can be selectively performed when the specification of gray-scale allocated to each sub-field is not satisfied by the mixed section T1 or, the mixed section T1 and the compensation section T3. As described in FIG. 5, operations of the common sustain section T2 can be performed after the mixed section T1 or the brightness compensation section T3.

The common sustain section T2 and the brightness compensation section T3 can be supplied or not supplied according to the sub-fields.

Whether to supply is determined according to specifications of gray-scales allocated to the sub-fields. In the case of the sub-field to which a low gray-scale is allocated, the sustain period required for realizing the gray-scale is relatively short. In the case of the sub-field to which a high gray-scale is allocated, the sustain period required for realizing the gray-scale is relatively long. Therefore, the sub-field having the low gray-scale may include only the address/sustain mixed section T1 and the sub-field having the high gray-scale may include all of the address/sustain mixed section T1, the common sustain section T2, and the brightness compensation section T3. The sub-field to which an intermediate level of gray-scale is allocated may include the address/sustain mixed period T1 and the brightness compensation section T3 without the common sustain section T2.

In FIG. 9, an example of the sub-field having a high gray-scale allocated thereto is illustrated. The length of the sustain period for each group varies in the mixed section T1 and thus operations of an additional sustain period are performed in each group so that the brightness of all cells is the same. For example, the brightness of the cells in the first group G1 is determined by the sum total of the sustain periods S11, S12, through to S1n performed during the mixed section T1 and the common sustain section T2. The cells of the first group have the highest brightness at the initial point of the brightness compensation section T3. In order for the cells in other groups to have the same brightness with the cells of the first group, operations of an additional sustain period S2n (this period corresponds to the first sustain period S1 of the first group) should be performed with respect to the cells of the second group G2, and operations of additional sustain periods S3, n-1, S3, and n which correspond to the first and second sustain periods S11 and S12 of the first group should be performed with respect to the cells in the third group G3.

With the methods described above, operations of additional sustain periods Sn2, Sn3, Sn,n should be performed on the cells in the last group Gn. Accordingly, all cells in the panel have the same brightness.

As described above, when the sustain periods with respect to all cells are completed, one action of the sub-field is followed by the reset period of the sub-field.

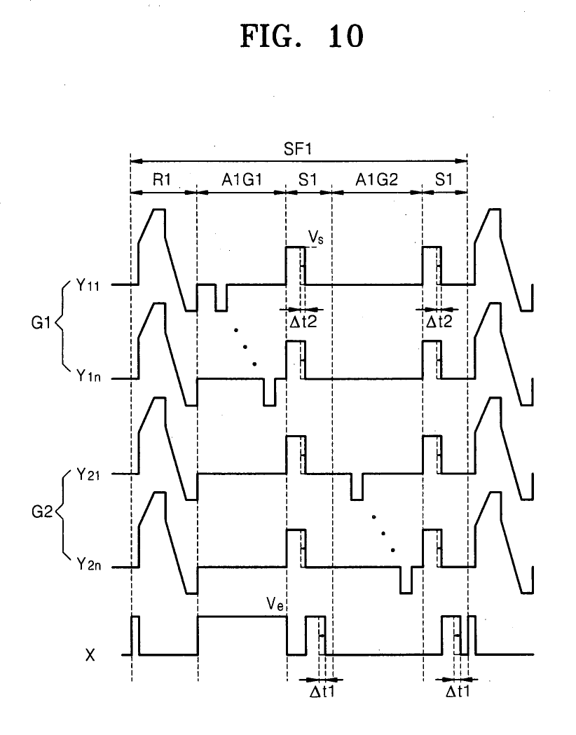

FIG. 10 is a timing diagram of driving signals outputted to electrodes of the PDP according to an embodiment of the present invention in the first sub-field of FIG. 9. For convenience of description, the Y electrodes are divided into two groups G1 and G2.

Referring to FIG. 10, in the reset period R1, a reset pulse is alternately supplied to a sustain electrode X and Y electrodes Y₁₁ through to Y₁ₙ, Y₂₁ through to Y₂ₙ in order to remove a sustain discharge and an address condition is formed.

Next, operations of the addressing section A1G1 of the first group G1 are performed. In this case, in the addressing section A1G1 of the first group G1, a bias voltage Ve is supplied to the sustain electrode X and a display cell is selected by turning on the Y electrodes Y₁₁ through to Y₁ₙ and the address electrodes which form cells that are to be displayed in the first group G1.

After operations of the addressing section A1G1 of the first group G1 is performed, a sustain pulse VS is alternately supplied to the sustain electrode and the Y electrodes Y₁₁ through to Y₁ₙ, Y₂₁ through to Y₂ₙ in order to perform sustain discharge S1 of the first group G1.

After the sustain discharge S1 of the first group G1 is performed, the operations of addressing section A1G2 of the second group G2 are performed. In this case, n Y electrodes Y_{21 l to Y}₂ₙ are included in the second group G2.

After operations of the addressing section A1G2 of the second group G2 are performed, a sustain pulse is alternately supplied to the sustain electrode X and the Y electrodes Y₁₁ through to Y₁ₙ, Y₂₁ through to Y₂ₙ in order to perform a sustain discharge S1 of the first and second groups G1 and G2.

In each sustain period S1 of the first sub-field SF1, a sustain pulse is sequentially supplied once to the Y electrodes Y₁ₙ, through to Y₁ₙ, Y₂₁ through to Y₂ₙ and the X electrode.

When the load factor of the first sub-field SF1 indicating the minimum weighted sub-field is lower than the reference load factor, the last sustain pulse of each sustain period S1 in the first sub-field SF1, that is, a width of the sustain pulse supplied to the X electrode, is reduced. Accordingly, unit light of the PDP is reduced and thus the low gray-scale displaying capacity can be improved.

According to the prior art, a brightness of approximately 4 cd/m² is achieved with a load factor of 1%. However, a brightness of approximately 3.6 cd/m² is achieved with the present invention, thereby reducing approximately 10% of the brightness in the present invention.

In addition, the sustain pulse just prior to the last sustain pulse, that is, the width of the sustain pulse supplied to the Y-electrodes Y₁₁ through to Y₁ₙ, and Y₂₁ through to Y₂ₙ, can be additionally reduced. In this case, the low gray-scale displaying capacity can be improved. However, the discharge stability may decrease. Therefore, as a decrease in width Δt1 of the last sustain pulse supplied to the X electrode is larger than a decrease in width Δt2 of the sustain pulse just prior to the last sustain pulse supplied to the Y electrodes Y₁₁ through to Y₁ₙ, and Y₂₁ through to Y₂ₙ, the discharge stability can be secured and the low gray-scale displaying capacity can be improved even more.

As described above, since the width of the last sustain pulse of the sustain period in the minimum weighted sub-field is changed based on a load factor, unit light is reduced and thus the low gray-scale displaying capacity can be improved.

In addition to the width of the last sustain pulse of the sustain period in the minimum weighted sub-field, while the width of a sustain pulse just prior to the last sustain pulse is reduced, the decrease in width of the last sustain pulse is larger than the width of the sustain pulse just prior to the last sustain pulse. In this case, the discharge stability can be secured and the low gray-scale displaying capacity can be improved even more.

Moreover, since the last sustain pulse of the sustain period in the minimum weighted sub-field, in which the width of sustain pulse is changed according to load factor, is supplied to the Y electrodes, a wall charge state of the Y electrodes formed of negative charges due to a reset operation is prevented from being disturbed. Therefore, a wall charge state of the Y electrodes is stably maintained and is advantageous for address discharge, and thus a stable address discharge is performed.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. A method of driving a Plasma Display Panel (PDP) having X, Y, and address electrodes, the method comprising:
dividing a unit frame, corresponding to a display cycle, into a plurality of sub-fields to display time ratio gray-scales, each sub-field including a reset period, an address period, and a sustain period;
alternately supplying a sustain pulse during the sustain period to X and Y electrodes based on a reference voltage; and
reducing a width of a last sustain pulse of the sustain period in a minimum weighted sub-field in response to a load factor of the minimum weighted sub-field having a lowest gray-scale among the plurality of sub-fields being lower than a reference load factor.

2. The method of claim 1, wherein the width of the last sustain pulse of the sustain period in the minimum weighted sub-field and a width of sustain pulse just prior to the last sustain pulse are decreased in response to the load factor of the minimum weighted sub-field being lower than a reference load factor.

3. The method of claim 2, wherein the decrease in width of the last sustain pulse is greater than the decrease in width of the sustain pulse just prior to the last sustain pulse.

4. The method of claim 1, wherein the last sustain pulse of the sustain period in the minimum weighted sub-field is supplied to the Y electrodes.

5. A method of driving a Plasma Display Panel (PDP) having cells divided into a plurality of groups and having the cells included in each group being addressed and a sustain discharge effected by X, Y, and address electrodes, the method comprising:
dividing one frame into a plurality of sub-fields, allocating a gray-scale realized by each sub-field differently, and determining a gray-scale according to visible brightness of the cells by selectively driving each sub-field;
wherein in at least one sub-field:
operations of the address period and the sustain period are sequentially performed with respect to the cells in each group, the sustain period operations are performed with respect to the cells of an addressed group after the address operations with respect to the cells in each group;
the address operations are performed on the cells in other groups after the sustain period has been completed; and
the sustain period operations are selectively performed on the cells in other groups in which the address operations have already been performed while the sustain period operations are being performed on the cells in any one of the groups;
alternately supplying a sustain pulse to the X and Y electrodes based on a reference voltage during the sustain period; and
reducing a width of the last sustain pulse of the sustain period in a minimum weighted sub-field in response to the load factor of the minimum weighted sub-field having the lowest gray-scale among the plurality of sub-fields being lower than a reference load factor.

6. The method of claim 5, wherein the width of the last sustain pulse of the sustain period in the minimum weighted sub-field and the width of the sustain pulse just prior to the last sustain pulse are decreased in response to the load factor of the minimum weighted sub-field being lower than the reference load factor.

7. The method of claim 6, wherein the decrease in width of the last sustain pulse is greater than the decrease in width of the sustain pulse just prior to the last sustain pulse.

8. The method of claim 5, wherein the last sustain pulse of the sustain period in the minimum weighted sub-field is supplied to the Y electrodes.

9. The method of claim 5, further comprising a common period in which the sustain period is commonly performed on cells included in all groups for a predetermined period.

10. The method of claim 5, further comprising a compensation period in which additional sustain period operations are selectively performed on cells in all groups for the cells in each group to satisfy a predetermined gray-scale.

11. An apparatus to drive a Plasma Display Panel (PDP) including X, Y, and address electrodes, the apparatus comprising:
electrode driving units to drive X, Y, and address electrodes with driving signals during each sub-field including a reset period and an address period and a sustain period, a unit frame corresponding to a display cycle including a plurality of sub-fields to display a time ratio gray-scale, and to alternately supply a sustain pulse to the X and Y electrodes based on a reference voltage during the sustain period;
a load factor detecting unit to detect load factors in each sub-field; and
a sustain pulse width control unit to decrease a width of a last sustain pulse of the sustain period in a minimum weighted sub-field in response to the load factor of the minimum weighted sub-field having the lowest gray-scale among the plurality of sub-fields being lower than a reference load factor.

12. The apparatus of claim 11, wherein the sustain pulse width control unit decreases the width of the last sustain pulse of the sustain period in the minimum weighted sub-field and a width of a sustain pulse just prior to the last sustain pulse in response to the load factor of the minimum weighted sub-field being lower than the reference load factor.

13. The apparatus of claim 12, wherein the sustain pulse width control unit decreases the width of the last sustain pulse more than that of the width of the sustain pulse just prior to the last sustain pulse.

14. The apparatus of claim 11, wherein the sustain pulse width control unit supplies the last sustain pulse of the sustain period in the minimum weighted sub-field to the Y electrodes.

15. An apparatus to drive a Plasma Display Panel (PDP) having cells divided into a plurality of groups and having cells included in each group being addressed and a sustain discharge being effected by X, Y, and address electrodes included therein, the apparatus comprising:
electrode driving units to supply driving signals to the X, Y, and address electrodes, the driving signals dividing one frame into a plurality of sub-fields, to allocate a gray-scale realized by each sub-field differently, and to determine a gray-scale according to visible brightness of the cells by selectively driving each sub-field; and, in at least one sub-field, the driving signals sequentially perform operations of the address period and the sustain period with respect to the cells in each group, perform the sustain period operations with respect to the cells of addressed group after the address operations with respect to the cells in each group, perform the address operations on the cells in other groups after the sustain period has been completed, and selectively perform the sustain period operations on the cells in other groups in which the address period operations have already been performed while the sustain period operations are being performed on the cells in any one of the groups; and to alternately supply a sustain pulse to the X electrodes and the Y electrodes based on a reference voltage during the sustain period;
a load factor detecting unit to detect load factors in each sub-field; and
a sustain pulse width control unit to reduce a width of a last sustain pulse of the sustain period in a minimum weighted sub-field in response to a load factor of a minimum weighted sub-field having the lowest gray-scale among the plurality of sub-fields being lower than the reference load factor.

16. The apparatus of claim 15, wherein the sustain pulse width control unit decreases a width of the last sustain pulse of the sustain period in the minimum weighted sub-field and a width of a sustain pulse just prior to the last sustain pulse in response to the load factor of the minimum weighted sub-field being lower than the reference load factor.

17. The apparatus of claim 16, wherein the decrease in width of the last sustain pulse is greater than the decrease in width of the sustain pulse just prior to the last sustain pulse.

18. The apparatus of claim 15, wherein the sustain pulse width control unit supplies the last sustain pulse of the sustain period in the minimum weighted sub-field to the Y electrodes.

19. The apparatus of claim 15, wherein the electrode driving units commonly perform the sustain period operations during a common period on cells included in all of the groups for a predetermined period.

20. The apparatus of claim 15, wherein the electrode driving units selectively perform additional sustain period operations during a compensation period on cells in all of the groups for the cells in each group to satisfy a predetermined gray-scale.
